(19) United States
(12) Patent Application Publication
(10) Pub. No.: US 2011/0220051 A1
(43) Pub. Date: Sep. 15, 2011

(54) Push Rod Retainer, Rocker Arm and Method for Retaining Together a Push Rod and a Rocker Arm

(75) Inventors: James D. Wotherspoon, Lincolnshire (GB); Jamie P. Smith, Peterborough (GB); Michael P. Ellero, Peterborough (GB)

(73) Assignee: PERKINS ENGINES COMPANY LIMITED, Peterborough (GB)

(21) Appl. No.: 13/130,179

(22) PCT Filed: Nov. 19, 2009
(86) PCT No.: PCT/EP2009/008257

§ 371 Date: May 19, 2011

(30) Foreign Application Priority Data
Nov. 24, 2008 (EP) 08169788.0

(51) Int. Cl. F01L 1/18; F02F 7/00

(52) U.S. Cl. 123/90.39; 123/195 R

(57) ABSTRACT

Disclosed is a push rod retainer for retaining an extremity of a push rod and a first end of a rocker arm in proximity of each other, comprising a base section accommodating at least a part of a junction space wherein the extremity of the push rod and a connection member of the rocker arm are joinable; and at least two resilient projections extending from the base section and at least partly in a direction towards each other, said resilient projections bounding a first entrance to the junction space. Also disclosed is a rocker arm having a connection member that is provided with a circumferential constriction configured for engagement by the resilient projections of the disclosed push rod retainer, and a method of retaining together a push rod and a rocker arm.

### TECHNICAL FIELD

The present disclosure is directed to overhead valve engines, and more in particular to overhead valve engines having retainers for holding elements of a valve actuator subassembly, such as a rocker arm and a push rod, in proximity of each other.

### BACKGROUND

Overhead valve engines are internal combustion engines wherein the intake and exhaust valves are located in the cylinder head while the camshaft is placed in the cylinder block. The valves may be actuated by the camshaft through the intermediation of lifters, push rods and rocker arms, in that order. Lifters, also known as tappets or lash adjusters, are often hydraulic in nature and serve to maintain zero valve clearance. A hydraulic lifter is able to take up valve train slack due to for example low engine temperatures, wear or incorrect adjustment, thereby eliminating tappet valve train noise. Typically, a hydraulic lifter comprises a pressure chamber that is intermittently filled with engine oil from an oil gallery via a small drilling. When a valve associated with the lifter is closed, the lifter is free to fill with oil. When the valve is opening and the lifter is being operated by the camshaft, the oil feed is blocked. The blockage substantially seals the pressure chamber, and the lifter acts much like a solid one would, oil being virtually incompressible.

When an engine remains unused for a relatively long period of time, on the order of days or weeks, there is the possibility that the pressure chamber will become emptied or pumped down. This condition may arise because when the engine is stopped, one or more cylinders may have valves in their open positions. As an open valve corresponds to a pressurized hydraulic lifter, the pressure chamber of the lifter may leak down over a prolonged period. A pumped down lifter may cause serious problems on startup. When the camshaft starts to turn while starting the engine, and the compressive load—or what is left thereof—is abruptly removed from the hydraulic lifter, the lifter may not be able to recover from its compressed length fast enough to eliminate the atypically large amount of clearance in the valve train that just arose. Consequently, the push rod, which is positioned in between the lifter and rocker arm, may detach from the rocker arm and topple sideways. When it does, it has become not only a dysfunctional component, but also an uncontrollable one that may for example be driven into other engine components by motion imparted to it by the revolving camshaft. This may obviously cause serious damage to the engine.

To prevent a push rod from toppling due to a relatively large play between the rocker end of the push rod and the rocker arm, either because of a pumped down hydraulic lifter or an other malfunctioning engine component, a push rod retainer may be used. Such a push rod retainer is known from WO 90/02249. The retainer disclosed therein cradles the cupped rocker end of a push rod in a pre-established proximity to a rocker arm provided with a ball pivot, and thus prevents the push rod from tipping or falling to one side.

Although the push rod retainer disclosed in WO 90/02249 may work largely satisfactorily, it embodies a number of drawbacks. For example, the push rod retainer is pre-assembled to the rocker arm: the ball pivot, which is larger than a hole in the retainer wall, is provided with a shank that goes through the hole in the retainer wall and is press fitted into a bore in the rocker arm. As a result, the retainer is troublesome to replace during servicing. Secondly, the push rod retainer is mounted immovably relative to the rocker arm. It is not supposed to touch the push rod, except when a malfunction of the engine occurs. Clearance relative to the push rod is provided for by tailoring the dimensions of the retainer to the dimensions of the push rod. Due to the repetitive angular movement of the push rod, the maximum amount of clearance between the retainer and the push rod will vary periodically. The amount of clearance is thus not constant, and at some points in time greater than desirable. After all, the larger the clearance between the push rod and the wall of the push rod retainer, the greater the possibility that the push rod will escape from the confines of the retainer cup.

The present disclosure is directed, at least in part, to improving or overcoming some aspects of known push rod retainers.

### SUMMARY

In one aspect a push rod retainer may be provided for retaining an extremity of a push rod and a first end of a rocker arm in proximity of each other. The push rod retainer may include a base section that may accommodate at least a part of a junction space wherein the extremity of the push rod and a connection member of the rocker arm may be joinable. It may also include at least two resilient projections. The projections may extend from the base section and may at least partly extend in a direction towards each other. The resilient projections may bound a first entrance to the junction space.

Another aspect of the present disclosure may be directed to a rocker arm. The rocker arm may have a connection member that is provided with a circumferential constriction configured for engagement by the resilient projections of a disclosed push rod retainer. The circumferential constriction may be provided behind an at least partly spheroidally shaped pivot head that is arranged on one end of the connection member, and in between a substantially square shoulder and a smooth and concave tapering that defines a transition between the pivot head and the constriction.

Another aspect of the present disclosure may be directed to an assembly. The assembly may include a disclosed push rod retainer, and a disclosed rocker arm. The resilient projections of the push rod retainer may engage the circumferential constriction of the connection member of the rocker arm.

In yet another aspect a method of retaining together a push rod and a rocker arm may be provided. The method may include attaching a resilient retainer to one of the push rod and the rocker arm such that the retainer cannot be removed therefrom without applying a removal force and such that relative movement of the retainer and the one of the push rod and the rocker arm is allowed. The method may further include enclosing an end of the other of the push rod and the rocker arm in a jacket-shaped portion of the retainer to prevent the push rod from falling sideways when the push rod and the rocker arm temporarily disengage.

### BRIEF DESCRIPTION OF THE DRAWINGS

FIG. 1 is a perspective view of an exemplary disclosed valve train;

FIG. 2 is a close-up perspective view of a mounted push rod retainer as shown in FIG. 1;

FIG. 3 is a perspective view of an exemplary disclosed push rod retainer as shown in FIGS. 1 and 2;

FIG. 4 is an orthogonal cross-sectional view of the push rod retainer shown in FIG. 3;

FIG. 5 is an orthogonal cross-sectional view of an alternative exemplary embodiment of a push rod retainer according to the present disclosure;

FIG. 6 is a cross-sectional view of a rocker arm—push rod connection that is secured by the exemplary push rod retainer of FIG. 3 and FIG. 4; and

FIG. 7 and FIG. 8 schematically illustrate the mounting of a disclosed push rod retainer onto a connection member of a rocker arm.

### DETAILED DESCRIPTION

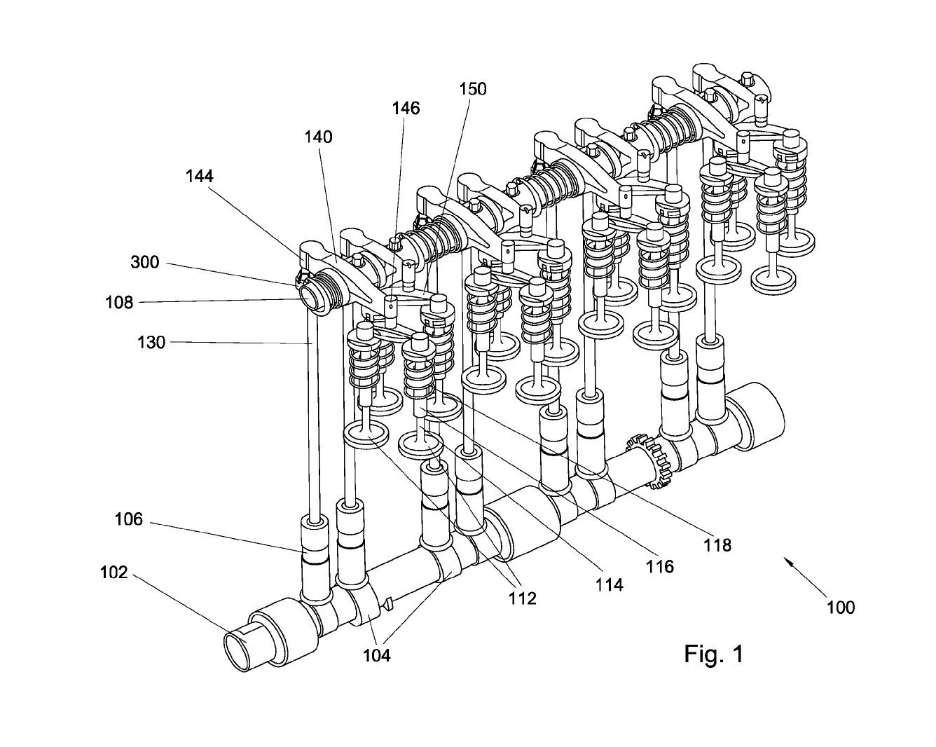

FIG. 1 illustrates an exemplary embodiment of a valve train 100 for use in an overhead valve engine. For the purpose of this disclosure, valve train 100 is depicted as a valve train for use in a four-cylinder, four-stroke, inline internal combustion engine, having four valves per cylinder. One skilled in the art will recognize however, that valve train 100 may embody a valve train for use in other types of overhead valve engines with any number of cylinders in any configuration, for example an inline or V-configuration.

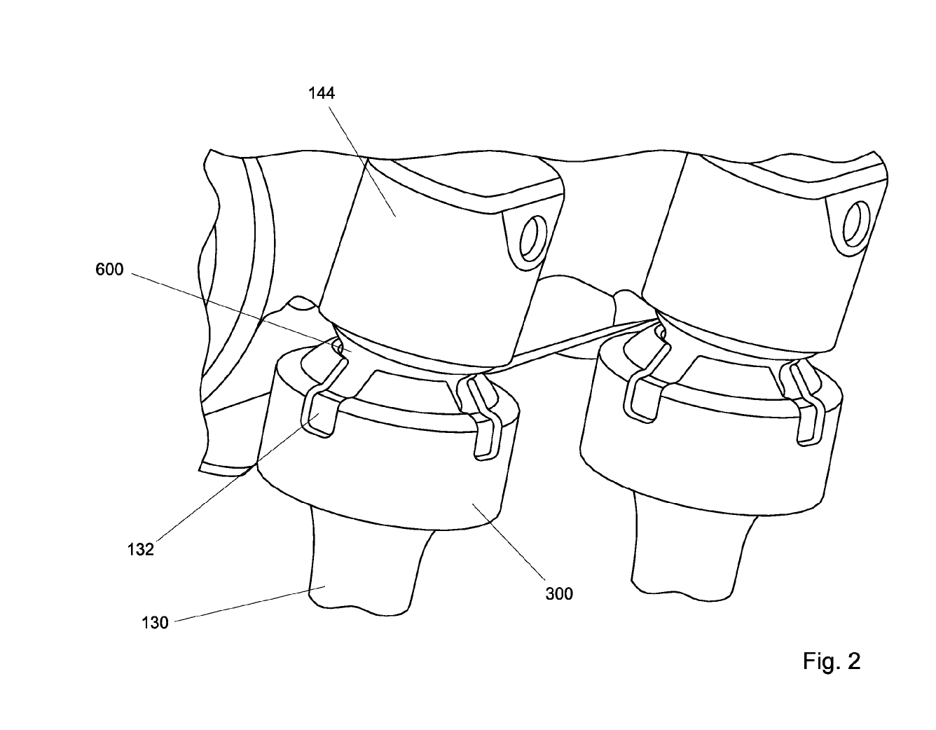

Valve train 100 may include a camshaft 102 of a conventional design, having cam lobes 104. In total, the depicted camshaft 102 features eight cam lobes 104, two for each cylinder of the four-cylinder engine with which valve train 100 may be used. Lifters 106, such as hydraulic tappets, may abut camshaft 102 where cam lobes 104 are provided so that a rotating motion of the camshaft results in a periodical activation of the lifters. Each lifter 106 may support a first end of an elongate push rod 130. A second end 132 of the push rod 130 may normally be in contact with a first end 144 of an associated rocker arm 140. The operable connection between a push rod end 132 and a first end 144 of a rocker arm 140 may be secured by a push rod retainer 300 (see for more detail FIG. 2).

A rocker arm 140 may be pivotably mounted on a rocker shaft 108 in a conventional manner. An actuation end 146 of a rocker arm 140—opposite the first end 144—may mechanically operate a valve 112. In the embodiment shown in FIG. 1, the actuation end 146 may engage a bridge 150 that may actuate a pair of valves 112. Each valve 112 may be provided on an end of a valve stem 114 that is slidably mounted within a valve stem guide 116. The upper end of a valve stem 114 may be connected to a valve spring 118 to bias the valve 112 towards its closed position, in touch with a valve seat.

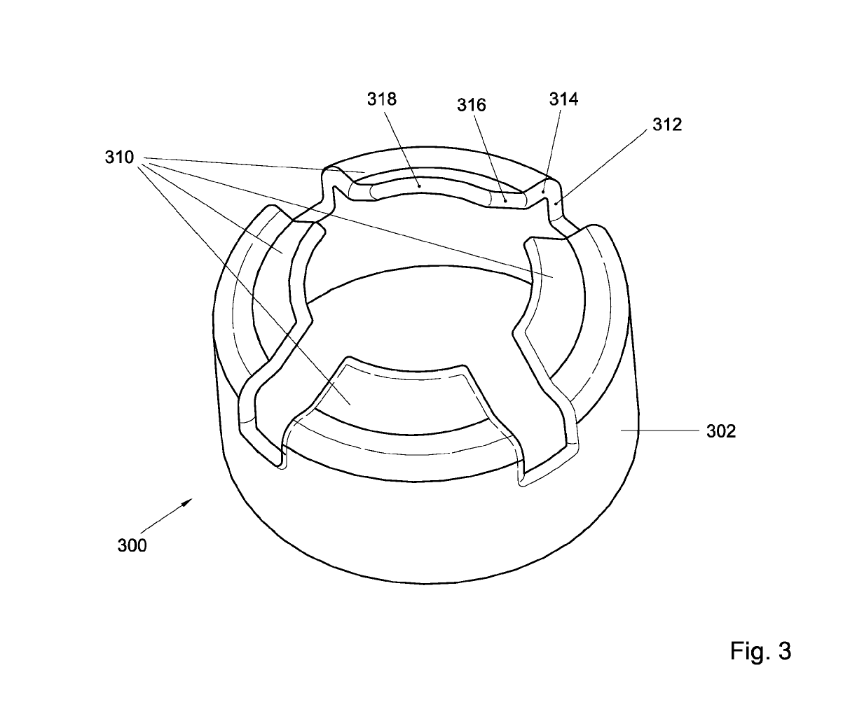

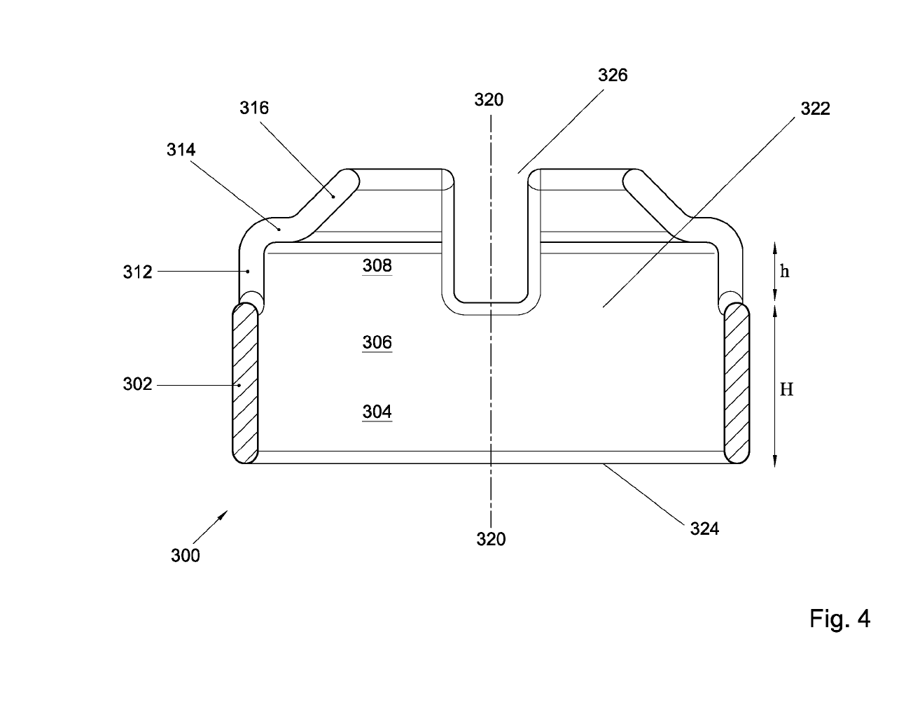

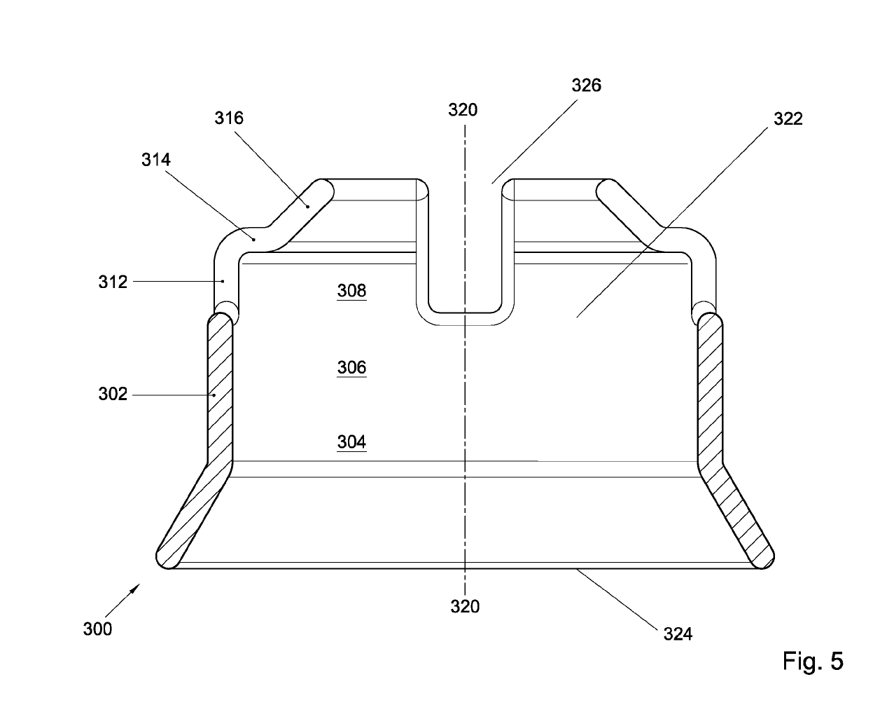

FIG. 3 and FIG. 4 show in isolation an embodiment of the push rod retainer 300 as shown in FIG. 2, in a perspective view and a cross-sectional view respectively. FIG. 5 shows a cross-sectional view of an alternative exemplary embodiment of a push rod retainer 300. Referring now in particular to FIG. 3, FIG. 4 and FIG. 5.

Push rod retainer 300 may include a base section 302 that bounds a passage 304 extending through the base section from a first end 322 to a second end 324. The passage 304 may form at least a (lower) part of a junction space 306 wherein an extremity 132 of a push rod 130 and a connection member 600 of a rocker arm 140 are joinable.

Passage 304 may be dimensioned to snugly receive the cupped end 132 of a push rod 130. Such a cupped end 132 may be substantially cylindrical for conventional push rods, but need not be. The cross-sectional shape of passage 304 may therefore vary for different embodiments of the disclosed push rod retainer 300, depending on the cross-sectional shape of the cupped end 132 for whose reception passage 304 is designed. It is noted, however, that even in case the cupped end 132 of a pushrod 130 has a circular cross-section, the passage 304 may have a cross-section that is not circular. It may, for example, have a polygonal cross-section with an inscribed circle that is slightly larger than the circular cross-section of the push rod's cupped end 132.

Though passage 304 is shown as having constant cross-sectional shape and area in FIG. 3 and FIG. 4, it is contemplated that both these parameters may vary along the length of the passage. FIG. 5, for example, shows an alternative exemplary embodiment of a push rod retainer 300 having a passage 304 with a constant circular cross-sectional shape, but a gradually increasing cross-sectional area towards a second end 324 thereof.

The outside shape of base section 302 may follow the contours of passage 304, so as to obtain a base section that is much like a sleeve. Accordingly, the base section 302 of the embodiment shown in FIG. 3 and FIG. 4 may be cylinder jacket-shaped, but it is contemplated that a base section may have different shapes, depending on, inter alia, the cross-sectional shape of the push rod's extremity 132 to be received and—as shown in FIG. 5—a varying cross-sectional area of the passage 304.

Attached to and extending from base section 302 may be a number of resilient projections 310. The embodiment depicted in FIG. 3 and FIG. 4 shows four identical projections 310. Each projection 310 includes three interconnected segments 312, 314, 316 that may be mutually different in orientation. Segments 312 may be directly connected to base section 302, and may extend substantially parallel to a central axis 320 thereof. Segments 314, disposed between segments 312 and 316, may extend in a direction towards and substantially perpendicular to the central axis 320. End segments 316 may extend in a direction away from base section 302, towards and substantially non-perpendicular to central axis 320 of the base section. Projections 310—in particular segments 314 and 316 thereof—may taper off as they extend towards central axis 320. Each end segment 316 may further be provided with an elliptically, in particular circularly curved edge 318, whose center of curvature may lie on the central axis 320. Together, the adjacent edges 318 may bound an opening 326 to junction space 306, while the adjacent resilient projections 310 outline and bound an (upper) part 308 of the junction space 306.

Though the exemplary embodiments of push rod retainer 300 depicted in FIG. 3 and FIG. 5 have four identical projections 310, each comprising three segments 312, 314, 316, it is contemplated that other embodiments of the disclosed push rod retainer may feature a different number of projections that need not be identical, and that may comprise a different number of differently oriented segments.

Push rod retainer 300 may be made in one piece, for example by injection moulding. In addition, push rod retainer 300 may be constructed from a plastic, such as engineering plastics including nylon.

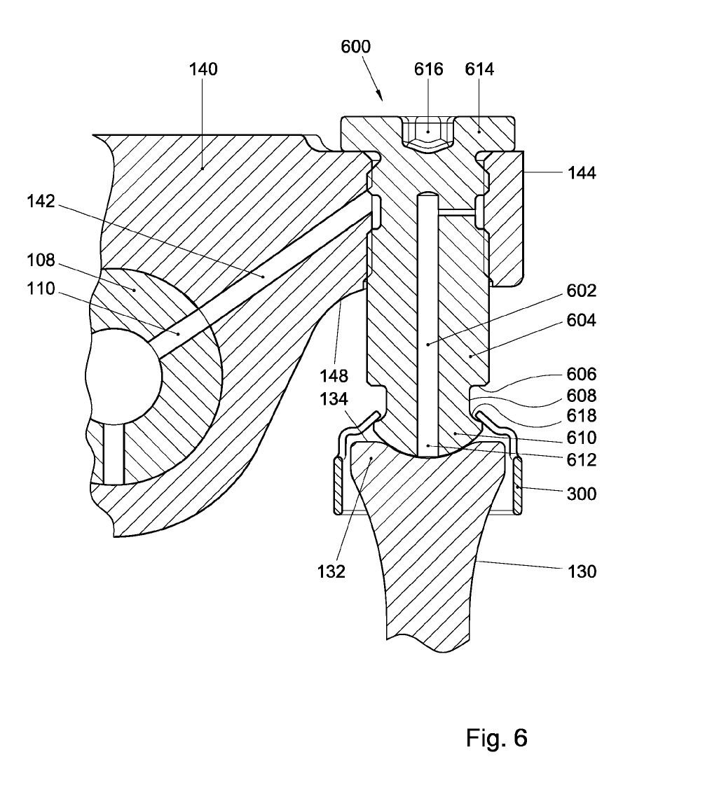

FIG. 6 is a cross-sectional view of a rocker arm 140—push rod 130 connection that is secured by the exemplary push rod retainer 300 of FIG. 3 and FIG. 4. As can be seen, the rocker arm 140 may include a connection member 600 that may be provided through the first end 144 of the rocker arm 140.

Connection member 600 may include a shank 604 that allows it to be inserted into a bore provided through the first end 144 of the rocker arm 140. Shank 604 may be substantially cylindrical, though other shapes are conceivable as well. To enable a reliable connection, an upper portion of shank 604 may be provided with an outer thread that may engage an inner thread provided on a wall bounding the shank-receiving bore in end 144. A head 614 may be provided on a top end of the partly threaded shank 604, so as to allow the connection member 600 to be inserted and/or removed much like a screw or bolt. To this end, the head may define at least one of an angular circumferential edge for engagement by a spanner and a socket 616 for engagement by a socket head wrench, a screwdriver or the like. Alternatively, shank 604 may be press fitted into the bore, or the rocker arm 140 may be manufactured including the connection member 600 as one piece.

Connection member 600 may further include a pivot head 610 that is provided at a lower end of the shank 604. The pivot head 610 may be at least partly spheroidally shaped and configured to complement a cupped end 132 of the push rod 130.

Seen along a longitudinal dimension of connection member 600, the shank 604 may further include a constriction 608. The constriction 608 may have a diameter that approximately corresponds to the diameter of the first entrance 326 to the junction space 306, outlined by the resilient projections 310 of the push rod retainer 300, in particular by the end segments 316 thereof. The constriction may be provided in between a substantially square shoulder 606 and the pivot head 610. A tapering transition 618 between the (back of) of the pivot head 610 and the constriction 608 may be concave and smooth.

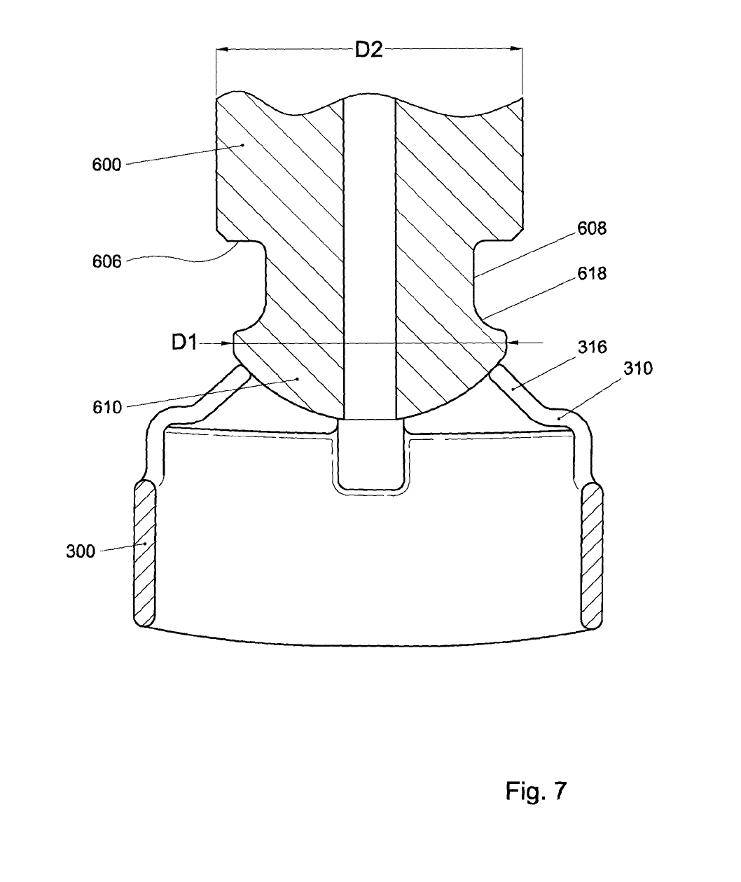

The relative dimensions of the portion of the shank 604 above the shoulder 606, which portion may have an outer diameter D2, and the pivot head 610, which may have an outer diameter D1, are preferably chosen such that D2>D1 (see FIG. 7 for indications of D1 and D2).

Rocker shaft 108, rocker arm 140 and connection member 600 may all be fitted with a lubricant channel for transporting a lubricant, such as oil, to the pivot head 610. The pivot head may in turn be fitted with a lubricant exit hole 612 to allow the lubricant to access a contact area between pivot head 610 and cupped end 132 of a push rod 130. The lubricant channels 110, 142, and 602 may be arranged in their respective host members 108, 140 and 600 such that at least an intermittent, pressurized flow of lubricant may be effected from rocker shaft 108 to pivot head 610 during operation of valve train 100.

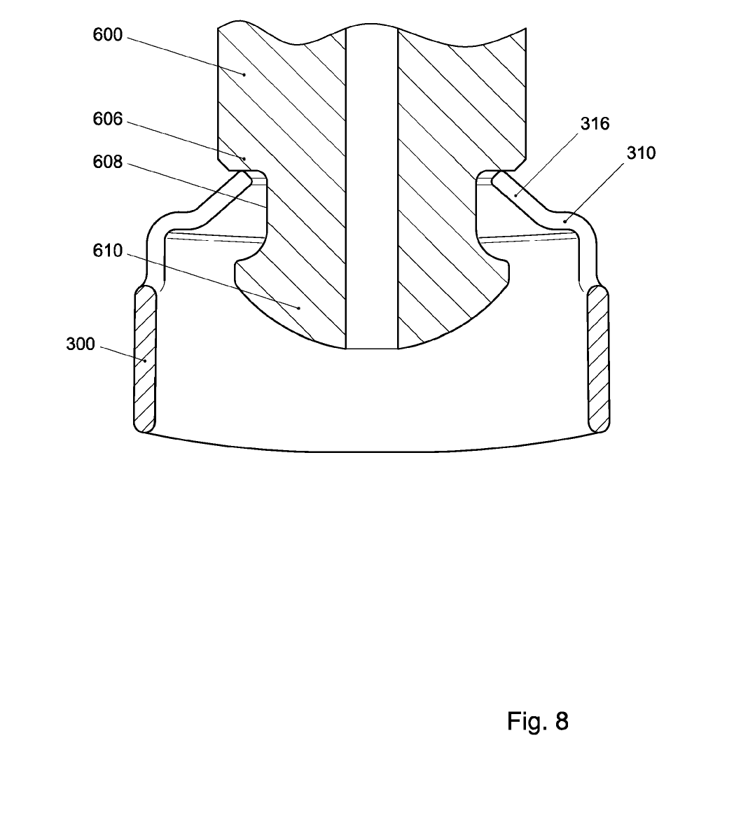

FIG. 7 and FIG. 8 schematically illustrate the mounting of a disclosed push rod retainer 300 onto a connection member 600 of a rocker arm 140. The push rod retainer 300 may be moved towards pivot the head 610, in the mutual orientation shown in FIG. 7, to the point when resilient the projections 310, in particular the segments 316 thereof, touch the surface of the pivot head 610. Applying some force while holding the push rod retainer 300 against connection member 600 may effect that the resilient projections 310 may be spread apart by the spheroidal surface of pivot head 610, so that the entrance opening 326 outlined by edges 318 of the end segments 316 may be temporarily enlarged. When entrance opening 326 has become sufficiently large, pivot head 610 may pass through. As push rod retainer 300 is moved further along connection member 600 the spread apart projections 310 may follow its circumferential contours. When end segments 316 encounter constriction 608, which may be preluded by a smooth tapering 618 of the connection member 600, the projections 310 may release the tension caused by their earlier deformation, and snap the push rod retainer 300 into place. This final position is shown in FIG. 8.

### INDUSTRIAL APPLICABILITY

Although this disclosure focuses on valve trains comprising a push rod-rocker arm linkage, push rod trains similar to the one shown in FIG. 1 may be used for other purposes, such as mechanical fuel injection, as well. See for example WO 90/02249. It is understood that the disclosed push rod retainer may also be applied in these similar but alternative-purpose mechanisms. In general, the disclosed push rod retainer may find application in any system where it may be advantageous to retain an extremity of a push rod and an end of a rocker arm in proximity of each other. The operation of push rod retainer 300 will now be explained.

Referring now to FIG. 1 and FIG. 2. During normal operation of the valve train 100, the camshaft 102 with the cam lobes 104 may rotate, which in turn may cause the hydraulic tappets 106 to reciprocally move the push rods 130 up and down. As a push rod 130 moves up, the first end 144 of the associated rocker arm 140 may move up accordingly, and may cause the rocker arm to pivot around the rocker shaft 108. The pivoting motion of the rocker arm 140 may be such that the actuation end 146 of the rocker arm may move downward, pressing on the valve stem 114, against the action of the valve spring 118, to displace the valve 112 from its valve seat. As the push rod 130 may move down again due to the continuing rotational motion of the cam lobe 104 that lifted it, the upward force on the push rod 130 may be relieved and the valve spring 118 may force the rocker arm 140 back into its starting position, thereby closing the valve. Thus, the valve train 100 may operate normally with push rod 130 reciprocally positioned between the hydraulic tappet 106 and the first end 144 of rocker arm 140.

In the background section of this text it is described how a temporarily malfunctioning hydraulic lash adjuster 106 may cause an uncontrolled motion of the push rod 130. Another example of a malfunction that could occur, and that might cause the first end 144 of the rocker arm 140 to remain in its elevated position—corresponding to an open valve—would be if the valve spring 118 was to seize or break, for example due to metal fatigue. Such valve spring failure may result in a situation wherein the upward force on the push rod 130 would be relieved, while the first end 144 of the rocker arm 140 would not be forced down. Consequently, the push rod 130 would become free of contact with the first end 144 of the rocker arm 140, resulting in the push rod 130 being free to topple sideways. When this would happen, the push rod 130 is no longer functional as it can no longer operate any valves. In addition, the rotating camshaft 102 may move the push rod 130 into contact with nearby components of an engine in which the valve train 100 is implemented, with sufficient force to seriously damage these components.

The disclosed push rod retainer 300 may prevent these effects of loss of contact between the push rod 130 and the rocker arm 140 by retaining the respective extremity 132 of the push rod 130 and a first end 144 of rocker arm 140 in proximity of each other. This can best be described with reference to FIG. 3, FIG. 4 and FIG. 6.

A pushrod retainer 300 may include a junction space 306 wherein the pivot head 610 of the connection member 600 of the rocker arm 140 and the cupped end 132 of the push rod 130 may be joinable. The push rod 130 and the connection member 600 may extend into the junction space 306 from opposite sides.

The cupped end 132 of the push rod 130 may extend into the junction space 306 through a second end 324 of a passage 304. Passage 304 may be dimensioned such that it may snugly receive the cupped end 132, at least at some points along its circumference. This would be to ensure that a central axis 320 of the push rod retainer 300 may remain substantially in alignment with a (longitudinal direction) of the push rod 130, despite the periodical angular movement of the push rod during valve train operation. The substantially constant and relatively small clearance between the circumference of the cupped end 132 of pushrod 130 and the wall bounding the passage 304 may reduce the chance that the cupped end 132 of the push rod 130 will escape from the confines of junction space 306 due to temporal variations in the amount of radial clearance during operation. In case the resilient projections 310 include segments 314, these segments 314 may provide for a stop against which a front face 134 of the cupped end 132 of the push rod 130 may abut.

Connection member 600 may be engaged by the resilient projections 310. The projections 310 may reach around the pivot head 610 to flexibly seize the connection member 600 at the constriction 608 that may be provided right behind it. This may position the pivot head 610 inside the junction space 306. Contact edges 318 of the resilient projections 310, which may be adapted to the circumferential shape of the connection member 600 at constriction 608, may provide for a fitting engagement that reliably locks the pivot head 610 inside the junction space 306. The engagement may preferably be such that push rod retainer 300 is somewhat moveable relative to the connection member 600, both pivotably and translationally in the longitudinal direction of the connection member 600. Such mobility relative to the connection member 600 enables the push rod retainer 300 to continuously adapt its orientation to the periodically changing mutual orientation of the pushrod 130 and the connection member 600. A gradual tapering 618 of the connection member 600 near the constriction 608, i.e. the smooth, concave contour flanking constriction 608, may assist in providing a flexible engagement. The gradual tapering 618 may also provide for a self-centering functionality of the push rod retainer 300 that may help to keep it in place. This may be because the extremum of constriction 608, relative to the gradually tapering flank 618, presents an energy minimum for the resilient projections 310. The resilient projections 310 may be guided naturally to this minimum as they may relieve internal tension that is inherent to any position on the flank 618.

To prevent the push rod retainer 300 from being pushed up too far along shank 604 of connection member 600, the constriction 608 may be bounded at an upper side thereof by a substantially square shoulder 606. The shoulder 606 does not facilitate the spreading apart of resilient projections 310 of the push rod retainer 300, and forms an effective barrier to any upward movement. Should, due to detrimental circumstances, the resilient projects 310 be forced apart anyway, then a relatively large diameter D2 of the upper part of the shank 604 may prevent the projections 310 from engaging the shank 604 at a position above the shoulder 606 that bounds the constriction 608.

Referring now in particular to FIG. 4, the height H of the wall of the push rod retainer 300, or when projection segments 312 are present the height H+h, may be chosen such that it is impossible for the cupped end 132 of the push rod 130 to slide out of the passage 304 in case of, for example, a hydraulic tappet 106 and/or valve spring 118 failure. For the valve train 100 shown in FIG. 1, this may mean that the height H respectively H+h may be at least equal to the distance over which the hydraulic tappet 106 may be expected to be pumped down under adverse circumstances, the height over which the push rod 130—in particular the cupped end 132 thereof—may be reciprocally displaced during normal operation, or the sum of these two values, depending on the type of failure the push rod retainer 130 is designed to anticipate.

The overall dimensions of the push rod retainer 300 may be kept as small as possible, both to save space and manufacturing material. Though the proportions of the push rod retainer 300 may partly be dictated by the push rod 130 and the connection member 600 to be used, it is worth noting that for example the thickness of the wall bounding the passage 304 need not be greater than structurally necessary. A sleeve-like base section 302 requires relatively little material to manufacture, and may minimize the size of the cut-away 148 in rocker arm 140 provided to accommodate the push rod retainer 300 during its arcuate movements when in use.

The process and materials used to fabricate push rod retainer 300 may reduce its cost and improve its reliability. Specifically, a one-piece design may improve the inherent strength of the retainer 300. In addition, injection moulding, as a low cost manufacturing method, may enable it to be fabricated economically from a plastic such as for example nylon, which is a relatively inexpensive material that offers good wear resistance and low specific weight.

The process of mounting the push rod retainer 300 onto a rocker arm 140 has been described above with reference to FIG. 7 and FIG. 8. Mounted push rod retainers may aid in assembling an engine, in particular in placing the rocker shaft assembly, i.e. the rocker shaft 108 and the rocker arms 140 mounted thereon. This is because a push rod retainer 300 mounted on a rocker arm 140 may engage a push rod 130 and guide it towards its seating position while the rocker shaft assembly is being installed. The exemplary push rod retainer 300 shown in FIG. 5, with its gradually widening passage 304 near the second end 324 thereof, may prove to be especially useful for this purpose.

In brief, here is how a push rod retainer 300, mounted on the connection member 600 of a rocker arm 140, may be made to engage the cupped end 132 of a push rod 130. After a push rod retainer 300 has been mounted on a connection member 600, which connection member 600 has itself been inserted into a bore through the rocker arm 140 prior to mounting of the retainer 300, the connection member 600 may be partially backed out of the rocker arm 140. In this position, the push rod retainer 300 may not be down low enough for the push rod end 132 to be received in the junction space 306 when the rocker shaft 108 holding the rocker arm 140 is placed in the engine. To establish a secured connection, the push rod 130 may be aligned with the rocker arm 140, and the connection member 600 may be threaded further into the (bore in the) rocker arm 140 towards a working position, whereby the push rod retainer 300 may be moved down to capture the end 132 of the push rod 130 and to guide it to its seating position opposite the pivot head 610 of the connection member 600. Finally, the connection member may be torqued against the rocker arm 140 such that the head 614 at the top of the connection member 600 fixingly contacts a flat surface on the top of the rocker arm 140 to define the working position. The opposite procedure may, of course, be performed when disassembling an engine, for example to replace the push rod, the push rod retainer or the connection member.

It will be clear that a disclosed push rod retainer 300 can easily be detached from a rocker arm during maintenance. Removal of a push rod retainer 300 from a connection member 600 merely requires a modest separating force to be exerted that is large enough to spread the resilient projections 310 apart, such that the opening outlined by in particular segments 316 may become sufficiently wide to allow the pivot head 610 to pass through. Such a force may be exerted manually, but cannot be provided by either the rocker arm 140 or the push rod 130 during operation of the valve train 100.

The push rod retainer 300 according to this disclosure has been described above as having a number of resilient projections 310 that may engage a connection member 600 of a rocker arm 140. One skilled in the art will recognize, however, that a push rod and a rocker arm may be designed such, that it is the push rod that includes a circumferential construction and a pivot head on one end thereof, while it is the rocker arm's connection member that includes a cupped end. Clearly, the disclosed push rod retainer 300 may be used in this case as well. Its resilient projections 310 may engage the pushrod, and may thereby lock its pivot head inside the junction space 306, while the cupped end of the connection member may be inserted into the junction space through the second end 324 of the passage 304.

It will be apparent to those having ordinary skill in the art that various modifications and variations can be made to the push rod retainer and the rocker arm—in particular the connection member thereof—as disclosed herein. Other embodiments will be apparent to those having ordinary skill in the art from consideration of the specification. It is intended that the specification and examples are considered as exemplary only. Other aspects, features and advantages will be apparent upon an examination of the attached drawings and appended claims.

1. A push rod retainer for retaining an extremity of a push rod and a first end of a rocker arm in proximity of each other, comprising:
a base section accommodating at least a part of a junction space wherein the extremity of the push rod and a connection member of the rocker arm are joinable; and
at least two resilient projections extending from the base section and at least partly in a direction towards each other, said resilient projections bounding a first entrance to the junction space.

2. The push rod according to claim 1, wherein the base section is substantially cylinder jacket-shaped.

3. The push rod retainer according to claim 2, wherein the base section includes a passage that at least partly defines the junction space said passage having a first end and a second end.

4. The push rod retainer according to claim 3, wherein the resilient projections extend from near a circumferential edge of a first end of the passage.

5. The push rod retainer according to claim 4, wherein a projection includes:
a first segment that extends in a direction towards and substantially perpendicular to a central axis of the base section; and
a second segment that extends in a direction away from the base section, towards and substantially non-perpendicular to the central axis of the base section, and that is directly connected to the first segment.

6. The push rod retainer according to claim 5, wherein a projection includes:
a segment that is directly connected to the base section, and that extends substantially parallel to a central axis of the base section.

7. The push rod retainer according to claim 6, wherein a segment of a projection that is directly connected to the base section is wider than a part of the projection that is more remote from the base section.

8. The push rod retainer according to claim 7, wherein an edge of a resilient projection near to the central axis of the base section is elliptically curved.

9. The push rod retainer according to claim 3, wherein the second end of the passage, seen in a direction from the second end to the first end of the passage, has a gradually decreasing cross-section.

10. The push rod retainer according to claim 9, wherein the push rod retainer is injection moulded, and made as a unitary piece.

11. A rocker arm having a connection member that is provided with a circumferential constriction configured for engagement by the resilient projections of a push rod retainer according to claim 10, wherein the circumferential constriction is provided behind an at least partly spheroidally shaped pivot head that is arranged on one end of the connection member, and in between a substantially square shoulder and a smooth and concave tapering that defines a transition between the pivot head and the constriction.

12. The rocker arm according to claim 11, wherein an outer diameter of the pivot heat is D1, wherein an outer diameter of the connection member at or just above the substantially square shoulder is D2, and wherein D1<D2.

13. The rocker arm according to claim 12, wherein a first end of the rocker arm is provided with a bore having an inner thread, and wherein the connection member is at least partially provided with an outer thread that is configured for cooperation with the inner thread, such that the connection member can be screwingly attached to the first end of the rocker arm.

14. The rocker arm according to claim 13, wherein an end of the connection member is provided with a head defining at least one of an angular circumferential edge for engagement by a spanner and a socket for engagement by a socket head wrench or a screwdriver.

15. An assembly comprising:
a push rod retainer with resilient projections; and
a rocker arm with a connection member having a circumferential constriction;
wherein the resilient projections of the push rod retainer engage the circumferential constriction of the connection member of the rocker arm.

16. A method of retaining together a push rod and a rocker arm, comprising:
attaching a resilient retainer to one of the push rod and the rocker arm such that the retainer cannot be removed therefrom without applying a removal force and such that relative movement of the retainer and the one of the push rod and the rocker arm is allowed; and
enclosing an end of the other of the push rod and the rocker arm in a jacket-shaped portion of the retainer to prevent the push rod from falling sideways when the push rod and the rocker arm temporarily disengage.
